(19) United States
(12) Patent Application Publication
(10) Pub. No.: US 2022/0219774 A1
(43) Pub. Date: Jul. 14, 2022

(54) VEHICLE MODULE FOR TRANSPORTING AT LEAST ONE PERSON AND A VEHICLE ASSEMBLY

(71) Applicant: Ningbo Geely Automobile Research & Development Co., Ltd., Ningbo (CN)

(72) Inventor: Lionel BELZONS, Nödinge (SE)

(21) Appl. No.: 17/710,265

(22) Filed: Mar. 31, 2022

Related U.S. Application Data
(63) Continuation of application No. PCT/CN2020/122440, filed on Oct. 21, 2020.

(30) Foreign Application Priority Data
Oct. 22, 2019 (EP) 19204651.4

(51) Int. Cl. B62K 27/12; B62J 43/16; B62D 63/04; B60L 53/12; B62K 21/00; B62M 7/02; B62K 11/04

(52) U.S. Cl. CPC B62K 27/12; B62J 43/16; B62D 63/04; B60L 53/12; B62J 1/00; B62M 7/02; B62K 11/04; B62K 2204/00; B62K 21/00

(57) ABSTRACT

A vehicle module for transporting at least one person includes at least two wheels, an electric motor, an electrical energy storage operationally connected to the electric motor for providing energy to the electric motor, and at least one connection means for securely attaching a vehicle module to another vehicle module or vehicle or to a charging or parking station, wherein at least one of the connection means, is arranged to connect the vehicle module to another vehicle module or vehicle so that the wheels of the vehicle module are parallel to the wheels of the connected vehicle module or vehicle, wherein, when the vehicle module is connected to another vehicle module or vehicle, a control unit of the vehicle module is adapted to take control over the steering of the other vehicle module or vehicle so as to drive the vehicle assembly as one vehicle.

### RELATED APPLICATION DATA

This application is a continuation of International Patent Application No. PCT/CN2020/122440, filed Oct. 21, 2020, which claims the benefit of European Patent Application No. 19204651.4, filed Oct. 22, 2019, the disclosures of which are incorporated herein by reference in their entireties.

### TECHNICAL FIELD

The present disclosure relates to a vehicle module for transporting at least one person and a vehicle assembly.

### BACKGROUND

Vehicles for transporting persons have a long tradition of being all-round vehicles that should serve a large number of different purposes. For that reason a personal vehicle normally has four or five seats and a relatively large trunk for storage of transported goods. However, the normal use of a personal vehicle is transportation of one person to and from work, wherein the vehicle is a lot larger than it has to be. This consumes more energy for transportation than is needed.

Vehicles have also traditionally been powered by an Internal Combustion Engine, which is starting to be phased out due to carbon dioxide emissions. Instead vehicles are developing to be powered by electricity. Electrification of the vehicle fleet, however, presents a number of new challenges for distributing and storing the electricity needed. Vehicles are normally equipped with a battery of some sort for storing electricity. The batteries are charged at charging stations at parking lots, and in the driveway or garage of many homes.

However, as the batteries are limited in storage capacity, expensive to manufacture and constitutes a heavy part in the vehicle, the battery is often a limiting factor for an electric vehicle in terms of available driving distance and for keeping a reasonable price of the vehicle.

Further, a problem that will arise when self-driving vehicles are introduced is that many roads will be closed for manual driving. Two-wheeled vehicles will thereby be stopped from using a large portion of available roads as such vehicles need manual driving for keeping balance of the vehicle.

Vehicles of the present state of the art are thereby in light of the above in need of improvements.

### SUMMARY

It is an object of the present disclosure to mitigate, alleviate or eliminate one or more of the above-identified deficiencies and disadvantages in the prior art and solve at least the above mentioned problem. According to a first aspect there is provided a vehicle module for transporting at least one person, comprising at least two wheels adapted for ground engagement, an electric motor operationally connected to the wheels for propelling the vehicle module. An electrical energy storage is operationally connected to the electric motor for providing energy to the electric motor. The vehicle module further comprises at least one connection means for securely attaching a vehicle module to another vehicle module or vehicle or to a charging or parking station, wherein at least one of the connection means, is arranged to connect the vehicle module to another vehicle module or vehicle so that the wheels of the vehicle module are parallel to the wheels of the connected vehicle module or vehicle. When the vehicle module is connected to another vehicle module or vehicle, a control unit of the vehicle module is adapted to take control over the steering of the other vehicle module or vehicle so as to drive the vehicle assembly as one vehicle.

The disclosed vehicle module has the advantage that the vehicle when connected to another vehicle of the vehicle no longer has a need of a driver balancing the combined vehicle. As one vehicle takes control of the other the vehicle the combined vehicle can keep balance without a driver. This also opens the possibility of autonomous driving controlled by the control unit. A bridge between driverless vehicles and vehicles requiring a driver is thereby established by connecting two vehicle modules. When a two-wheeled scooter e.g. approaches a road that is dedicated for self-driving vehicles and thereby closed for human drivers, the two-wheeled scooter can connect with another vehicle and become a driverless vehicle.

According to some embodiments, at least one charging means, which is operationally connected to the energy storage and adapted to be operationally connected to another vehicle module or vehicle for providing charging electricity to and/or receive charging electricity from said another vehicle module or vehicle.

The disclosed solution thus makes it possible to connect two vehicles to each other and share battery power. E.g. if one vehicles has a depleted battery and the other vehicle has a full battery, the vehicle with a full battery can provide energy to the first vehicle so that it can continue driving, e.g. to a charging station.

According to some embodiments, the connections means further comprises an electrical steering connection for establishing an electrical connection via communication wires between the respective control units of the vehicle module and a connected other vehicle module.

A reliable connection between the control unit of the first vehicle module and the control unit of the other vehicle module is thereby established. Wired data connections are preferable over wireless connections when it comes to system critical operations like the steering of a vehicle, as malfunction would affect traffic safety severely.

According to some embodiments, the vehicle module further comprises a self-driving sensor module. Such a self-driving sensor module comprises all prior art sensors required by the control unit to acquire relevant and necessary information about the surroundings to operate the vehicle module autonomously. Sensors included are e.g. cameras, proximity sensors, distance sensors, etc.

According to some embodiments, the vehicle module comprises two of said at least one charging means. The vehicle can then share charging electricity with another vehicle while charging its own battery at a charging facility. In that way if all charging stations are occupied it is possible to attach the vehicle to another vehicle to charge from there.

According to some embodiments, the at least one charging means further comprises a respective connection means for securely attaching a vehicle module to another vehicle module or vehicle or to a charging or parking station. The connection means enable a secure connection so that e.g. a vehicle with two wheels will not tip over.

According to some embodiments, a first charging means of the at least one charging means is positioned at a first lateral or medial side of the vehicle module, and a second charging means of the at least one charging means is positioned at a second lateral or medial side of the vehicle module. In some embodiments it may be desired to have the connection means on the side of the vehicles for charging and/or sharing the battery power with other attached vehicles. However, in other embodiments it may be desired to have the charging means at the front and back of the vehicle so that the vehicle, e.g. when charging in a narrow garage or when charging from another vehicle when being parked behind or in front of another vehicle, e.g. at the side of a road.

If a vehicle has charging means with connection means in the front and back additional charging can also be made on the fly. One vehicle can connect to a vehicle in front of it while driving and either be towed while charging or help driving the two connected vehicles. More than two vehicles can then be connected to form a train where charging may be shared between any two or more vehicles while the train is driving at normal speed.

According to some embodiments, the vehicle comprises four of the at least one charging means, wherein the charging means are placed one at each of the front side of the vehicle module, the back side of the vehicle module, the left side of the vehicle module and the right side of the vehicle module, respectively. The vehicle can then connect to vehicles in any direction.

According to some embodiments, the connection means are electromagnetic connections means. This enables a strong connection that in a simple way can align also the charging means. Docking becomes simpler.

According to some embodiments, the at least one charging means are induction charging couplings. In that way no open conductors have to be present and problems of road dust and dirt in rainy weather is no longer a problem. No lids are required for protection of conductors as in normal plug-and socket solutions. In some embodiment, however, the charging is facilitated via normal conductors. However, as charging has to be able to flow in both directions a male-female plug and socket solution is not optimal to use. A flush charging means may be used, e.g. with ring conductors. A charging means with symmetrical protrusions and recesses is also possible, e.g. so that a left connector of one vehicle always may connect with right connector of another vehicle. In some embodiments the charging means may be rotated when connecting to vehicles to make the connection correctly.

According to some embodiments, at least one of the connection means, is arranged to connect the vehicle module to another vehicle module or vehicle so that the wheels of the vehicle module are parallel to the wheels of the connected vehicle module or vehicle. The two vehicles can then connected to each other while driving. According to some embodiments, the vehicle module is identical to a connected other vehicle module. Two vehicles connected side-to-side will then form a broader vehicle possible to drive as one. If each vehicle has two wheels as a motorcycle the combined vehicle will instead resemble a car.

According to some embodiments, when the vehicle module is connected to another vehicle module or vehicle, a control unit of the vehicle module is adapted to take control over the steering of the other vehicle module or vehicle so as to drive the vehicle assembly as one vehicle. In some embodiments the operator or driver may also choose which vehicle should command the other while driving.

According to some embodiments, the control unit is adapted to take control over the steering of the other vehicle module or vehicle only when being positioned on the left side when in right-hand traffic, and only when being positioned on the right side when in left-hand traffic. In that way a the combined vehicle will be driven from the correct side. In right-hand traffic, the steering wheel on four plus wheel vehicles are placed on the left side for traffic safety reasons and the other way around in left-handed traffic. The vehicle module may be pre-programmed with a setting of either left-hand traffic or right-handed traffic. When a vehicle module connects to another vehicle module, the control units will communicate and based on the pre-programmed setting choose which vehicle module will take control over the steering for the combined vehicle in accordance with the logic described above.

According to some embodiments, the vehicle module has preferably has at least one seat. The seat may also be surrounded by a user compartment so that vehicle occupants are protected from weather. In some embodiment the user compartment has at least one door.

According to some embodiments, the user compartment is shaped so that when two vehicles are connected and the door is opened, the user compartments of the two vehicles are joined and can be shared for easier social interaction while driving or battery sharing. The door may be available at the side of the vehicle and/or at the front and back of the vehicle so that the user compartment may be expanded in the direction where another vehicle is connected.

According to some embodiments, the engine is a hub engine on one or each wheel facilitating efficient drive of the vehicle.

According to some embodiments, the vehicle module has a luggage compartment under the seat to efficiently use al volume of the vehicle. Further luggage compartments may also be present in some embodiments.

According to a second aspect there is provided a vehicle assembly comprising a plurality of vehicle modules according to the first aspect. The vehicle assembly can be any number of vehicles connected in series or in parallel to form a cluster of vehicles where the user compartment can be expanded to one large user compartment for social interaction or better storage of goods. Battery energy can then be shared between any vehicles.

Effects and features of the second aspect are to a large extent analogous to those described above in connection with the first aspect. Embodiments mentioned in relation to the first aspect are largely compatible with the second aspect.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claims, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1 shows a perspective view of a vehicle according to an embodiment of the present disclosure.

FIG. 2 shows a perspective view a vehicle assembly according to an embodiment of the present disclosure.

FIG. 3 shows a schematic view of a vehicle of an embodiment of the present disclosure with two vehicle occupants in the vehicle.

FIG. 4 is an exploded view showing the charging means and connection means of a vehicle of one an embodiment of the present disclosure.

FIG. 5 is a perspective view of the vehicle of FIG. 1 charging from a charging station via a charging means of the vehicle.

FIG. 6 is a perspective view of a vehicle assembly according to the present disclosure with vehicles connected in series.

FIG. 7 is a schematic drawing of two vehicle modules connected to form a vehicle assembly.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

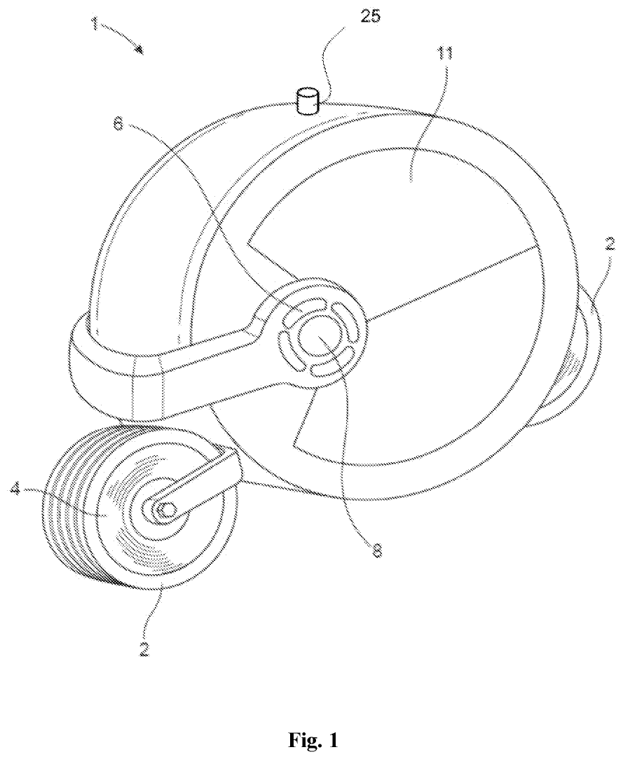

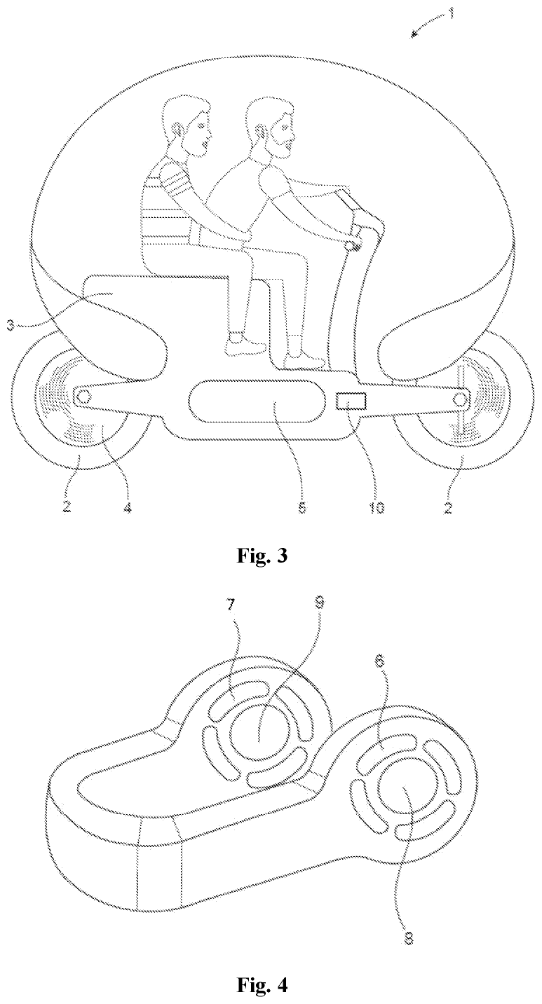

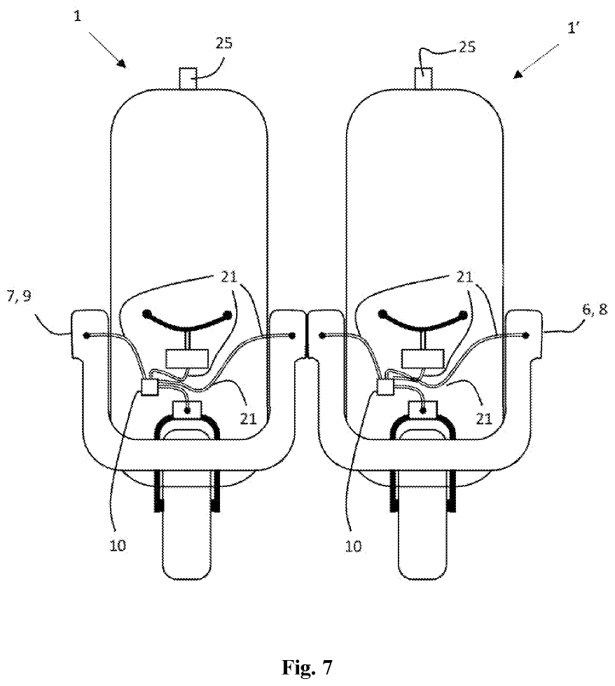

FIG. 1 shows the first aspect of this disclosure with a vehicle module 1 for transporting at least one person, comprising at least two wheels 2 adapted for ground engagement, an electric motor 4 operationally connected to the wheels for propelling the vehicle module 1, an electrical energy storage 5 operationally connected to the electric motor 4 for providing energy to the electric motor 4, and at least one charging means 8, which is operationally connected to the energy storage 5 and adapted to be operationally connected to another vehicle module 1′ or vehicle for providing charging electricity to and/or receive charging electricity from the another vehicle module 1′ or vehicle. The vehicle has a user compartment with a door 11 that can be opened for the occupants of the vehicle to enter or exit the vehicle. On top of the vehicle module a self-driving sensor module 25 for collecting sufficient information about the environment to let the control unit 10 (shown in FIGS. 3 and 7) drive the vehicle module autonomously.

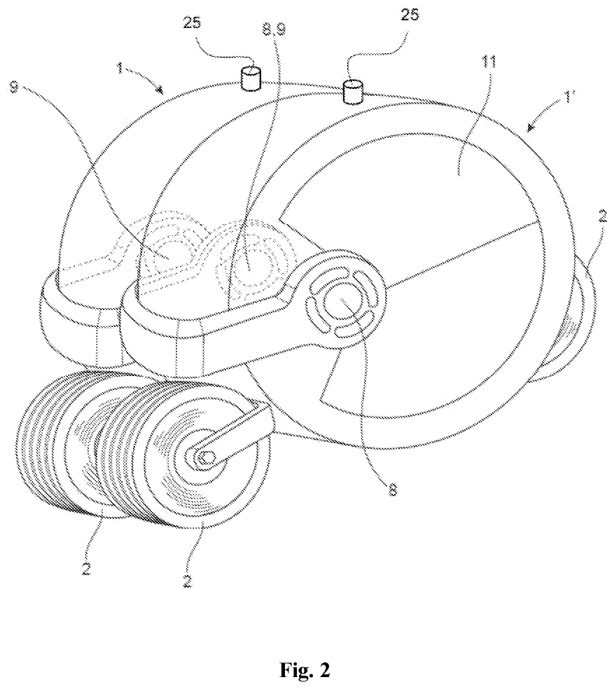

The first charging means 8 of the at least one charging means 8, 9 is positioned at a first lateral or medial side of the vehicle module 1, and a second charging means 9 of the at least one charging means 8, 9 is positioned at a second lateral or medial side of the vehicle module 1. In FIG. 1 this is embodied so that the vehicle can connect at the lateral sides of the vehicle as further shown in FIG. 2.

In one embodiment, depicted in FIGS. 1-5 the vehicle module further comprises two of said at least one charging means 8, 9, one on each side. As seen in FIG. 2, one vehicle 1 can then share its battery energy with another vehicle 1′ or the other way around. The at least one charging means comprises a respective connection means 6, 7, 13, 14 for securely attaching a vehicle module 1 to another vehicle module 1′ or vehicle or to a charging or parking station 17. At least one of the connection means 6, 7, is arranged to connect the vehicle module to another vehicle module 1′, as shown in FIG. 2, so that the wheels 2 of the vehicle module 1 are parallel to the wheels of the connected vehicle module 1′. In FIG. 2 the vehicle module 1 is identical to the connected other vehicle module 1′. The connection means 6, 7 are in the depicted embodiment electromagnetic connections means. This leads to that the vehicle can enable the connections means and also disable any of them so as to avoid connecting to other vehicles or charging stations when not intended or wanted.

FIG. 3 shows a schematic view of a vehicle 1 of an embodiment of the present disclosure with two vehicle occupants in the vehicle 1. The vehicle has a seat 3 under which a luggage compartment 12 is placed. A battery is placed low in the frame of the vehicle together with a control unit 10. In the embodiment shown in FIGS. 1-6 the engine is a hub engine 4 on one or each wheel.

FIG. 4 shows an exploded view of the two sets of charging means 8, 9 and connection means 6, 7 of the vehicle 1 shown in FIGS. 1, 2, 5 and 6. The connecting part may contain the cables and conductors needed between the two charging means while at the same time facilitating safety in the event of an accident. The shackle-formed part may be used for retrofitting electrical vehicles lacking the charging means and coupling means necessary for being part of the charging infrastructure disclosed herein.

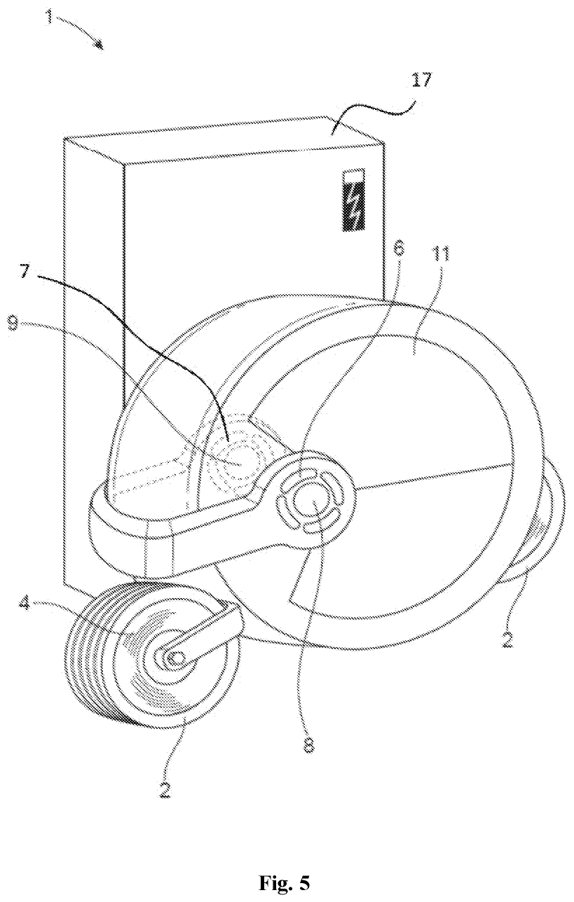

FIG. 5 is a perspective view of the vehicle of FIG. 1 charging from a charging station via a charging means of the vehicle. The vehicle 1 is connected to the charging station via the charging means 9 and the connections means 7 while charging. If the charging station is not needed for other vehicles, the vehicle may remain at the charging station until the vehicle is used the next time.

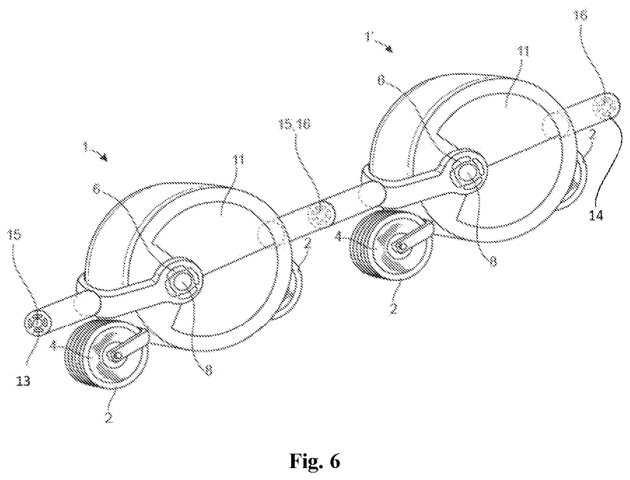

FIG. 6 is a perspective view of a vehicle assembly according to the present disclosure with vehicles connected in series. The vehicles shown in FIG. 6 comprises four of the at least one charging means 8, 9, 15, 16, wherein the charging means 8, 9, 15, 16 are placed one at each of the front side of the vehicle module, the back side of the vehicle module, the left side of the vehicle module and the right side of the vehicle module, respectively. This means that the vehicles can connect to other vehicles or charging stations at all four sides of the vehicle. Vehicles can thus in that way be connected in matrix formations.

The at least one charging means 8, 9, 15, 16 are in the depicted embodiments induction charging couplings, which is convenient as the charging means 8, 9, 15, 16 then are completely flush and no male-female-connection is needed. It is, however, possible to use charging means with normal conductors still achieving all other benefits of the current disclosure. Referring to FIG. 3, when the vehicle module is connected to another vehicle module 1′ or vehicle, a control unit 10 of the vehicle module 1 is adapted to take control over the steering of the other vehicle module 1′ or vehicle so as to drive the vehicle assembly as one vehicle. In that way two identical vehicles may be connected as in FIG. 2 and driven as one vehicle that now has four wheels instead of two. By opening the doors between the vehicles, the user compartment is enlarged and doubles in space enabling social interaction between occupants and/or the possibility to transport larger objects.

The control unit 10 of FIG. 3 is adapted to take control over the steering of the other vehicle module 1′ or vehicle only when being positioned on the left side when in right-hand traffic, and only when being positioned on the right side when in left-hand traffic. The combined vehicle shown in FIG. 2 is then very close to a normal car, even though it is composed by two detachable motorcycle like vehicles.

Referring to FIG. 2 and FIG. 7, the connections means 6, 7, 13, 14 of the vehicle modules 1, 1′ further comprises electrical steering connections 22, 23 for establishing electrical connection via communication wires 21 between the respective control units 10 of the vehicle module 1 and the connected other vehicle module 1′. A reliable connection between the control unit of the first vehicle module 1 and the control unit 10 of the other vehicle module 1′ is thereby established. Wired data connections are preferable over wireless connections when it comes to system critical operations like the steering of the combined vehicle, as malfunction would affect traffic safety severely. As further seen in these figures each vehicle module comprises a self-driving sensor module 25. Such a self-driving sensor module 25 comprises all prior art sensors required by the control unit to acquire relevant and necessary information about the surroundings to operate the vehicle module autonomously. Sensors included are e.g. cameras, proximity sensors, distance sensors, etc.

The second aspect of this disclosure shows a vehicle assembly comprising a plurality of vehicle modules according to the first aspect. FIGS. 2 and 7 show a combined vehicle where two vehicles are attached to each other in parallel. FIG. 6 shows another possibility where two vehicles are attached to each other in series. A combination of the disclosures of FIG. 2 and FIG. 6 would lead to a vehicle composed by four vehicle modules 1, 1′ in a matrix formation.

Exemplary vehicle modules are set out in the following items.

1. A vehicle module (1) for transporting at least one person, comprising:

at least two wheels (2) adapted for ground engagement,

an electric motor (4) operationally connected to the wheels for propelling the vehicle module (1),

an electrical energy storage (5) operationally connected to the electric motor (4) for providing energy to the electric motor (4), and

at least one charging means (8, 9), which is operationally connected to the energy storage (5) and adapted to be operationally connected to another vehicle module (1′) or vehicle for providing charging electricity to and/or receive charging electricity from said another vehicle module (1′) or vehicle.

2. The vehicle module (1) according to item 1, wherein the vehicle module comprises two of said at least one charging means (8, 9).

3. The vehicle module (1) according to item 1 or 2, wherein the at least one charging means further comprises a respective connection means (6, 7, 13, 14) for securely attaching a vehicle module (1) to another vehicle module (1′) or vehicle or to a charging or parking station (17).

4. The vehicle module (1) according to item 2, wherein a first charging means (8) of the at least one charging means (8, 9) is positioned at a first lateral or medial side of the vehicle module (1), and a second charging means (9) of the at least one charging means (8, 9) is positioned at a second lateral or medial side of the vehicle module (1).

5. The vehicle module (1) according to any one of the preceding items, further comprising four of the at least one charging means (8, 9, 15, 16), wherein the charging means (8, 9, 15, 16) are placed one at each of the front side of the vehicle module, the back side of the vehicle module, the left side of the vehicle module and the right side of the vehicle module, respectively.

6. The vehicle module (1) according to any one of the preceding items, wherein the connection means (6, 7) are electromagnetic connections means.

7. The vehicle module (1) according to any one of the preceding items, wherein the at least one charging means (8, 9, 15, 16) are induction charging couplings.

8. The vehicle module (1) according to any one of the preceding items, wherein at least one of the connection means (6, 7), is arranged to connect the vehicle module to another vehicle module (1′) or vehicle so that the wheels (2) of the vehicle module (1) are parallel to the wheels of the connected vehicle module (1′) or vehicle.

9. The vehicle module (1) according to any one of the preceding items, wherein vehicle module (1) is identical to a connected other vehicle module (1′).

10. The vehicle module (1) according to any one of the preceding items, wherein, when the vehicle module is connected to another vehicle module (1′) or vehicle, a control unit (10) of the vehicle module (1) is adapted to take control over the steering of the other vehicle module (1′) or vehicle so as to drive the vehicle assembly as one vehicle.

11. The vehicle module (1) according to item 10, wherein the control unit (10) is adapted to take control over the steering of the other vehicle module (1′) or vehicle only when being positioned on the left side when in right-hand traffic, and only when being positioned on the right side when in left-hand traffic.

12. The vehicle module (1) according to any one of the preceding items, wherein the vehicle module (1) has at least one door.

13. The vehicle module (1) according to any one of the preceding items, wherein the vehicle module (1) has at least one seat (3).

14. The vehicle module (1) according to any one of the preceding items, wherein the engine is a hub engine on one or each wheel.

15. A vehicle assembly comprising a plurality of vehicle modules according to any one of items 1-14.

The person skilled in the art realizes that the present disclosure is not limited to the preferred embodiments described above. The person skilled in the art further realizes that modifications and variations are possible within the scope of the appended claims. For example, it is understood that any number of vehicles may be attached to each other to form any matrix formation of vehicles where the vehicles may share battery power and where the formation is driven and controlled by one suitable vehicle. It is further understood that the control unit includes processing capabilities and memory with adequate information for driving the vehicle autonomously, including maps and software to perform autonomous driving in line with the prior art. Additionally, variations to the disclosed embodiments can be understood and effected by the skilled person in practicing the claimed disclosure, from a study of the drawings, the disclosure, and the appended claims.

What is claimed is:

1. A vehicle module for transporting at least one person, comprising:
at least two wheels adapted for ground engagement,
an electric motor operationally connected to the wheels for propelling the vehicle module,
an electrical energy storage operationally connected to the electric motor for providing energy to the electric motor,
at least one connection means for securely attaching a vehicle module to another vehicle module or vehicle or to a charging or parking station, and
at least one charging means, which is operationally connected to the energy storage and adapted to be operationally connected to another vehicle module or vehicle for providing charging electricity to and/or receive charging electricity from said another vehicle module or vehicle,
wherein at least one of the connection means, is arranged to connect the vehicle module to another vehicle module or vehicle so that the wheels of the vehicle module are parallel to the wheels of the connected vehicle module or vehicle,
wherein, when the vehicle module is connected to another vehicle module or vehicle, a control unit of the vehicle module is adapted to take control over the steering of the other vehicle module or vehicle so as to drive the vehicle assembly as one vehicle.

2. The vehicle module according to claim 1, wherein the vehicle module comprises two of said at least one charging means.

3. The vehicle module according to claim 1, wherein the connections means further comprises an electrical steering connection for establishing an electrical connection via communication wires between the respective control units of the vehicle module and a connected other vehicle module.

4. The vehicle module according to claim 1, further comprising a self-driving sensor module.

5. The vehicle module according to claim 1, wherein a first charging means of the at least one charging means is positioned at a first lateral or medial side of the vehicle module, and a second charging means of the at least one charging means is positioned at a second lateral or medial side of the vehicle module.

6. The vehicle module according to claim 1, further comprising four of the at least one charging means, wherein the charging means are placed one at each of the front side of the vehicle module, the back side of the vehicle module, the left side of the vehicle module and the right side of the vehicle module, respectively.

7. The vehicle module according to claim 1, wherein the connection means are electromagnetic connections means.

8. The vehicle module according to claim 1, wherein the at least one charging means are induction charging couplings.

9. The vehicle module according to claim 1, wherein vehicle module is identical to a connected other vehicle module.

10. The vehicle module according to claim 1, wherein the control unit is adapted to take control over the steering of the other vehicle module or vehicle only when being positioned on the left side when in right-hand traffic, and only when being positioned on the right side when in left-hand traffic.

11. The vehicle module according to claim 1, wherein the vehicle module has at least one door.

12. The vehicle module according to claim 1, wherein the vehicle module has at least one seat.

13. The vehicle module according to claim 1, wherein the engine is a hub engine on one or each wheel.

15. A vehicle assembly comprising a plurality of vehicle modules according to claim 1.
